(19) United States
(12) Patent Application Publication
(10) Pub. No.: US 2026/0147239 A1
(43) Pub. Date: May 28, 2026

(54) RAPID AND PARALLELIZED MANUFACTURING OF MODULAR LIGHT-DIFFUSER DEVICES

(71) Applicant: Adobe Inc., San Jose, CA (US)

(72) Inventors: Tenell Glen Rhodes, San Jose, CA (US); Sandeep Zechariah George Kollannur, Kochi (IN); Gavin Stuart Peter Miller, Los Altos, CA (US)

(73) Assignee: Adobe Inc., San Jose, CA (US)

(21) Appl. No.: 18/958,816

(22) Filed: Nov. 25, 2024

(51) Int. Cl. G02F 1/1335; G02F 1/1334

(52) U.S. Cl. CPC G02F 1/133504; G02F 1/1334

(57) ABSTRACT

In implementations of rapid and parallelized manufacturing of modular light-diffuser devices, a method includes scoring busbar outlines on each side of a polymer dispersed liquid crystal (PDLC) film sheet for multiple petals of a modular light-diffuser system. Magnets used to prepare the PDLC film sheet for scoring are simultaneously placed and removed using a magnet lift system. A busbar on each sheet side is then exposed for multiple petals, with easy-peel tabs being utilized to simplify exposing the tabs on each petal. Liquid crystal is efficiently wiped away from the tabs and busbars using a hand tool or sponge machine attachment. The petal shapes are cut out to finish the process, with laser welding of the film sheet to a backing along the petal edges to create an air gap. One implementation eliminates the busbar peeling and cleaning steps by lining the film sheet with metal strips.

### BACKGROUND

Polymer-dispersed liquid crystal (PDLC) film is used to create modular light-diffuser devices that function as pixels or petals for displays on various surfaces, such as clothing or buildings. Machines can cut these PDLC-based film sheets into petals with different shapes, but assembling the petals into a cohesive display involves multiple manual post-processing steps. These steps are completed sequentially and involve handling each petal individually, making it impractical to manufacture common display resolutions such as High Definition (HD) with 1280×720 pixels or 4k with 4096×2160 pixels.

### SUMMARY

Techniques and systems for rapid and parallelized manufacturing of modular light-diffuser devices are described herein. Multiple modular light-diffuser devices can be grouped together and flexibly added (e.g., like sequins) to clothing, fabrics, walls, and other surfaces to form patterns, designs, and animations based on the modular light-diffuser devices changing states. Similarly, the modular light-diffuser devices can be joined to form large format displays, where each modular light-diffuser device functions as a petal or pixel.

In one example, a manufacturing process includes scoring busbar outlines on each side of a PDLC film sheet for multiple petals of a modular light-diffuser system with multiple modular light-diffuser devices. The petals can be manufactured with orthogonal or parallel-quad tabs to allow the busbars for multiple petals to be scored along orthogonal or parallel axes, respectively. Magnets used during the scoring process are simultaneously placed and removed from the work area using a magnet lift system to reduce the preparation time significantly. The busbar on each side is simultaneously exposed along the scored axes for multiple petals. Easy-peel tabs are created using cuts along an overcut line and a tab line to simplify the exposure of the ITO tabs on each petal.

Liquid crystal is then wiped away from the exposed busbar for multiple petals at a time using a hand tool or a sponge attached to a computer numerical control (CNC) machine. The petal profiles are then cut out to finish the manufacturing process. The PDLC sheet is laser welded to a backing along the petal edges to create an air gap. One implementation eliminates the busbar peeling and cleaning steps by lining the PDLC film sheet with a grid of metal strips. In this way, the described techniques and systems allow petals for high-resolution displays to be efficiently and rapidly manufactured.

This Summary introduces a simplified selection of concepts described below in the Detailed Description. As such, this Summary is not intended to identify essential features of the claimed subject matter or to aid in determining its scope.

### BRIEF DESCRIPTION OF THE DRAWINGS

The patent or application file contains at least one drawing executed in color. The Office will provide copies of this patent or patent application publication with color drawing(s) upon request and payment of the necessary fee.

The detailed description is described with reference to the accompanying figures. Entities represented in the figures indicate one or more entities, and thus, reference is made interchangeably to single or plural forms of the entities in the discussion.

FIG. 1 illustrates an environment in an example implementation that is operable to employ rapid and parallelized production techniques for modular light-diffuser devices, as described herein.

FIGS. 2A through 2G is a flow diagram depicting a step-by-step procedure in an example implementation of operations performable for rapid and parallelized production of modular light-diffuser devices.

FIGS. 3A through 3E illustrate an example of a magnet lift system to support rapid and parallelized production techniques for modular light-diffuser devices, as described herein.

FIGS. 4A and 4B illustrate an example of a PDLC sheet usable to employ rapid and parallelized production techniques for modular light-diffuser devices, as described herein.

FIG. 5 illustrates example configurations of PDLC diffuser elements by the techniques described herein.

FIG. 6 illustrates an example of a computing device according to aspects of the techniques described herein.

### DETAILED DESCRIPTION

### Overview

There has been an increased development of non-emissive light display systems that can be affixed to objects, including surfaces on portable objects (e.g., clothing and textiles) and less portable objects. These non-emissive light-display systems generally utilize a low-voltage generated alternating current that rotates the direction of electrical polarity to power a polymer-dispersed liquid crystal (PDLC) diffuser component and enable the PDLC diffuser component to change from a scattering state to a transparent state. Multiple modular light-diffuser devices can be grouped together and flexibly added (e.g., like sequins) to clothing or fabrics to form patterns, designs, and animations based on the changing states of modular light-diffuser devices. Similarly, the modular light-diffuser devices can be joined to form large format displays, where each modular light-diffuser device functions as a petal. Further, the modular light-diffuser devices can include touch elements to facilitate individual or group state changes (e.g., between the light-scattering and non-light-scattering states) based on touch input.

The modular light-diffuser device generally utilizes one or more diffuser components with one or more backing layers or materials positioned under each diffuser component. In one or more implementations, the diffuser component includes a combination of layers made of different materials. For example, the diffuser component can include polyethylene terephthalate (PET) layers, conductive coating layers, and a polymer layer that includes liquid crystal molecules (e.g., a PDLC film layer). The diffuser component changes states from the light-scattering state (e.g., diffuse or at least partially obscured) to the non-light-scattering state (e.g., transparent or at least translucent) when an electrical current is applied. The configuration of the modular light-diffuser device enables a low-voltage direct current (DC) power source to provide generated alternating current (AC) through the diffuser component (e.g., the PDLC film layer). In this manner, the diffuser component can operate safely and without rapidly deteriorating. The modular light-diffuser devices also utilize a busbar (e.g., a conductive strip) attached to the edges of the PDLC film to distribute electrical voltage evenly across the film.

PDLC film is often used for large application surfaces (e.g., smart windows), so the PDLC film is not usually cut down to small sizes or needed in large quantities. PDLC sheets are generally cut to size with scissors, die-cutting machines, or laser cutters, but the busbars are usually made with a handheld blade.

Conventional production of PDLC petals follows a similar procedure. To begin, the adhesive-backed PDLC sheets are mounted on a backing material. A laser cutter or other cutting mechanism scores the busbar lines and cuts out the petals (e.g., a petal shape). A top layer of the busbar is then hand cut away to expose the conductive coating layer (e.g., indium tin oxide (ITO) layer) for the liquid crystal to be cleaned off. As described above, this conventional procedure makes PDLC petal production for high-resolution displays impractical.

In contrast, this document describes techniques and systems for rapid and parallelized production of modular light-diffuser devices. The described techniques minimize the individual handling of PDLC petals and hand tools by completing the third step of the conventional procedure in parallel for each adjacent petal in a sheet before the petal shape is cut out in the conventional second step. The first conventional step of mounting the adhesive-backed PDLC sheet to a backing is also eliminated by laser-welding the backing to the PDLC and introducing a magnet lift system to handle the workload in the second step quickly. Carefully tuned cut settings expose the conductive layer without any tools, and the cleaning in step three is removed if a metal-lined PDLC is used. If cleaning is required, the cleaning is accelerated with a hand tool or fully automated with a detachable sponge mount for CNC machines. Accordingly, the described techniques and systems combine to boost PDLC petal production capacity by several orders of magnitude.

As illustrated by the foregoing discussion, this document utilizes a variety of terms to describe the features and advantages of the described techniques and systems. For example, as used herein, the terms “PDLC diffuser component,” “diffuser component,” or “diffuser element” refer to a portion of a modular light-diffuser device that selectively scatters or allows the passage of light. A diffuser element can include a sheet, screen, film, or material layer that can alternate between a non-light-scattering state that allows light to pass through and a light-scattering state that scatters light, thereby preventing at least some light from passing through. The diffuser component can be composed of a material that, in response to electrical stimulation, transitions from a diffused appearance (e.g., in the light-scattering state) to a transparent appearance (e.g., in the non-light-scattering state) or vice-versa. For example, the diffuser element includes a PDLC film that can alternate between a non-light-scattering state and a light-scattering state.

In addition, as used herein, the terms “light-scattering state,” “scattering state,” or “scattered state” refer to a state of an object that scatters light. When an object scatters light, the light directed at the object is refracted at various angles (e.g., making the object appear diffuse or at least partially opaque). When a modular light-diffuser device is in a light-scattering state, the modular light-diffuser device becomes diffuse and blocks or otherwise obscures (at least partially) the view of backing or material layer(s) behind the modular light-diffuser device.

As used herein, a “non-light-scattering state” refers to a state of an object that allows all (or nearly all) light directed at the object to pass through the object without blur or attenuation. When a modular light-diffuser device is in a non-light-scattering state, the modular light-diffuser device becomes transparent and allows the view of backing or material layer(s) behind the modular light-diffuser device.

The following discussion describes an example environment that employs the techniques described herein. Example procedures are also described as performable in the example and other environments. Consequently, the performance of the example procedures is not limited to the example environment, and the example environment is not limited to the performance of the example procedures.

### Example Modular Light-Diffuser Environment

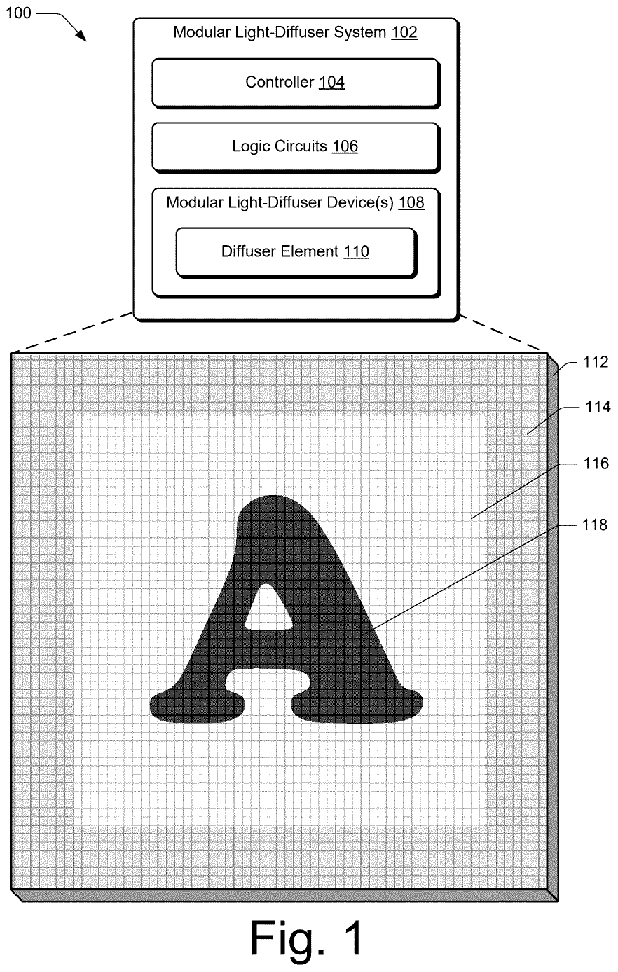

FIG. 1 illustrates an environment 100 in an example implementation that is operable to employ rapid and parallelized production techniques for modular light-diffuser devices as described herein. In particular, FIG. 1 illustrates a wall surface (e.g., of a building) with a modular light-diffuser system 102. The modular light-diffuser system 102 includes a controller 104, logic circuits 106, and modular light-diffuser devices 108, which are operable in various states, and each includes one or more diffuser elements 110.

FIG. 1 illustrates many modular light-diffuser devices 108 arranged as a decorative material or arrangement on a wall 112. When power is cut off to the modular light-diffuser devices 108, the modular light-diffuser devices 108 become opaque (e.g., white, cloudy, and/or diffuse). In contrast, driving power to the modular light-diffuser devices 108 or a subset thereof causes them to reveal the reflective material or layers of material (e.g., mylar) behind the diffuser elements 110 of the modular light-diffuser devices 108, revealing the first, second, and third patterns 114, 116, and 118. In other implementations, the modular light-diffuser devices can be partially activated to become partially opaque (e.g., in between the “white” of the opaque state and the color of the reflective material). In another implementation, the second pattern 116 is generated by not activating the corresponding modular light-diffuser devices.

Different groups of modular light-diffuser devices 108 are powered in various implementations to create different pixelated designs. In other implementations, the modular light-diffuser devices 108 switch between different designs to create animations (e.g., based on a user providing touch input or triggering a logic circuit). To illustrate, wall 112 can animate different letters and/or words by alternating between different activation states in different patterns.

In some implementations, the underlying surface (e.g., wall 112) has a reflective background material behind the diffuser elements 110. However, the material of the surface can vary in substance, color, and design. For example, in some implementations, the surface material is a dark or colored fabric. In one or more embodiments, the surface material has a printed or woven pattern that appears when the diffuser elements 110 are in the transparent state.

The modular light-diffuser system 102 changes the state of the diffuser elements 110 (e.g., between the light-scattering state and the non-light-scattering state) as well as provides generated alternating current to the diffuser elements 110 based on sending signals to the logic circuits 106 via the controller 104. In some implementations, the modular light-diffuser system 102 includes additional logic circuits 106 and modular light-diffuser devices 108 (e.g., a grid of modular light-diffuser devices controlled by logic circuits 106).

The wall 112 is illustrated as including a pattern (e.g., the third pattern 118 of a letter “A”) of diffuser elements 110. As shown, the first, second, and third patterns 114, 116, and 118 form designs comprised of the diffuser elements 110 arranged into a grid of rows and columns to create a dense dot matrix of petals (e.g., texture pixels or texels). In various implementations, diffuser elements 110 are fastened to one or more circuit boards (e.g., rigid or flexible), which are attached to the wall 112 by taping or otherwise fastening them (e.g., crimping, screwing, gluing, sewing) to the wall 112. For example, the diffuser elements 110 and/or circuit board include one or more small holes that allow them to be fastened on like sequins. Because diffuser elements 110 are connected via a flexible conductor and are not rigidly connected, the diffuser elements 110 along with the circuit board can be attached in a manner that does not meaningfully impede movement or use of the object or surface by a user.

Each diffuser element 110 can change from a light-scattering state to a transparent state when power is applied. For example, when diffuser elements 110 are not powered, they can appear white, cloudy, diffuse, or at least partially opaque. If wall 112 is similar in color and material, the diffuser elements 110 appear hidden in the light-scattering state. When power is applied, the diffuser elements 110 become transparent, revealing the fabric or material beneath them. For example, when the diffuser elements 110 are placed above a reflective, mirror-like material, the mirror is visible when the diffuser elements 110 are in a transparent state.

FIG. 1 illustrates the modular light-diffuser system 102, including multiple diffuser elements 110. The diffuser element 110 comprises a PDLC diffuser component with a PDLC diffuser film layer in one or more implementations. As also shown, the modular light-diffuser device 108 is connected to a logic circuit 106 managed by a controller 104 (e.g., a microcontroller). The logic circuits 106 include, but are not limited to, analog switches, d-type latches, shift registers, LED/full bridge drivers, and digital logic switches that operate at specified voltages.

Controller 104 provides a control signal to the logic circuit 106 to indicate when each logic circuit 106 should provide power to the modular light-diffuser device 108. In addition, controller 104 provides a synchronization clock to synchronize the logic circuits 106 with each other. For example, controller 104 utilizes, but is not limited to, a Serial Peripheral Interface (SPI) to provide input signals, power, clock signals, and other signals to the logic circuit 106. In various implementations, the controller 104 is, but is not limited to, a microprocessor having memory (e.g., RAM) and programmed instructions (e.g., in hardware or software) to manage the modular light-diffuser system 102.

In addition, in some implementations, the modular light-diffuser system 102 includes hardware and/or software that facilitates sending and receiving data from an external source. For example, the modular light-diffuser system 102 receives designs, patterns, and/or animations to display on a set of modular light-diffuser devices 108 and/or diffuser elements 110. For instance, the modular light-diffuser system 102 communicates with a phone application to receive one or more stored designs. Similarly, the modular light-diffuser system 102 can receive animations from a proximity beacon at an event (e.g., a concert or fashion show), from adjacent objects, or other modular light-diffuser devices 108 (e.g., a fixed modular reflective light-diffuser device display or another individual wearing modular reflective light-diffuser devices). In various implementations, the modular light-diffuser system 102 receives wireless transmissions (e.g., WI-FI, Bluetooth, NFC). In alternative implementations, the modular light-diffuser system 102 downloads designs, patterns, and/or animations via a physical port (e.g., a data and recharging port). Further, the modular light-diffuser system 102 can receive one or more stored designs via flash memory, such as an SD card.

The modular light-diffuser system(s) 102 can attach to many types of objects, especially portable objects. For example, one or more modular light-diffuser systems 102 can be incorporated into clothing items, such as jewelry, bags, shoes, belts, scarves, and other accessories. Further, modular light-diffuser systems 102 can be added to the surface(s) of cars and busses, walls, windows, signs, and other portable and non-portable objects of any size to create small and large displays. Similarly, because of their small individual size and flexibility, diffuser elements 110 can be molded or heat treated to the shape of nearly any object or display, including curved surfaces (e.g., a dome or a sphere).

Multiple modular light-diffuser systems can be added to an object or surface in various implementations. For example, a wall surface can include multiple sets of modular light-diffuser systems (e.g., a controller, logic circuits, and modular light-diffuser devices). The modular light-diffuser systems can be located adjacent to or apart from one another as nodes or panels.

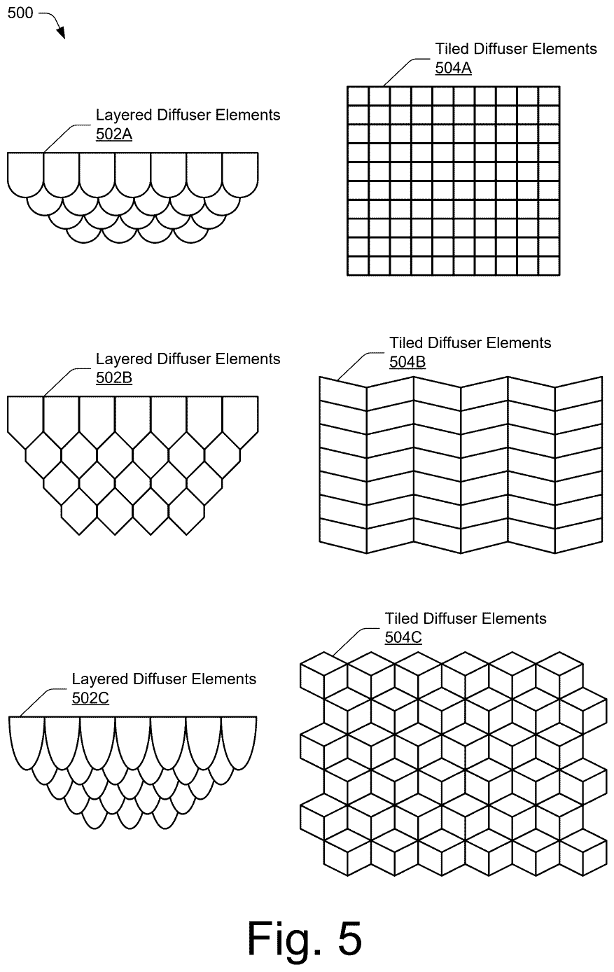

FIG. 5 illustrates example configurations 500 of PDLC diffuser elements in accordance with the techniques described herein. As mentioned above, diffuser elements 110 can range in shape, size, layout, and arrangement. FIG. 5 illustrates example configurations 500 of diffuser elements 110 in accordance with one or more implementations. The diffuser elements 110 can be arranged as layered diffuser elements 502A, 502B, or 502C or as tiled diffuser elements 504A, 504B, and 504C.

As also shown in FIG. 5, the diffuser elements 110 can vary in shape and size individually and collectively. In various implementations, the diffuser elements 110 are square (e.g., 0.25 inches square), as illustrated with the tiled diffuser elements 504A. In other implementations, the diffuser elements 110 are parallelograms arranged as tiles, as illustrated with the tiled diffuser elements 504B or 504C, or petal-shaped in a layered arrangement, as illustrated in the layered diffuser elements 502A, 502B, and 502C. In alternative implementations, some diffuser elements 110 are rectangular, oval, rounded, curved, pointed, and/or concave to match a designed pattern or design (e.g., edges of various diffuser elements 110 can be curved to match one or more designs). Further, some diffuser elements 110 are shaped into thin strips in one or more implementations.

In various implementations, a diffuser element 110 can be divided into separate segments (e.g., cut into strips), which can create a striped effect as the power is pulled down across the film layer (e.g., creating a “bar graph” effect). In additional implementations, the top and bottom conductive layers (e.g., ITO layers) of the diffuser elements 110 can be segmented in different orientations. For example, the top layer is cut in a horizontal direction, and the bottom layers are cut vertically, creating a grid pattern as power is provided to the diffuser elements 110.

In various implementations, the PDLC diffuser elements 110 show internal designs or patterns when in the transparent state. For example, various diffuser elements 110 have a white polka dot stenciled on their top layer hidden when the diffuser element 110 is in the light-scattering state and are revealed when the diffuser element 110 is in the transparency state. The diffuser elements 110 can include a variety of designs or patterns thereon, such as feathers, flowers, or stripes. Further, such patterns and designs can span multiple diffuser elements 110.

PDLC diffuser elements 110 and corresponding modular light-diffuser devices 108 can be utilized on various types of surfaces, including surfaces of portable and non-portable objects. For example, a wall can include a swatch of modular light-diffuser devices 108 forming a pattern (e.g., a heart shape). The backing material can be a reflective material (or another color or material as described above) and the pattern is formed by having diffuser elements 110 within the pattern in a non-powered light-scattering state while the diffuser elements 110 outside of the pattern are in a non-light-scattering state, which reveals the backing material behind.

In addition, PDLC diffuser elements 110 and corresponding modular light-diffuser devices 108 can be attached to multiple types of clothing items, such as jewelry, bags, shoes, belts, scarves, and other accessories. Further, modular light-diffuser devices 108 can be added to the surface(s) of cars and buses, walls, windows, signs, and other objects. To illustrate, a bus can include a dot matrix pixel grid or matrix of modular light-diffuser devices controlled by a modular light-diffuser system to change states in a prearranged pattern. Because PDLC diffuser elements 110 are non-emissive and modulate ambient light, the modular light-diffuser devices 108 are able to create rich visual effects, even in direct sunlight, which many current LED systems struggle to do.

In general, functionality, features, and concepts described in the examples above and below are employed in the context of the example procedures described in this section. Further, functionality, features, and concepts described with different figures and examples in this document are interchangeable and are not limited to implementation in the context of a particular figure or procedure. Moreover, blocks associated with different representative procedures and corresponding figures herein are applicable together and/or combinable in different ways. Thus, individual functionality, features, and concepts described with different example environments, devices, components, figures, and procedures herein are usable in any suitable combinations and are not limited to the particular combinations represented by the enumerated examples in this description.

### Example Manufacturing Procedure

The following discussion describes manufacture techniques of modular light-diffuser devices that are implementable utilizing the described systems and devices. The procedure is illustrated as a set of blocks that specify operations performable and are not necessarily limited to the orders shown for performing the operations by the respective blocks. In portions of the following discussion, reference will be made to FIGS. 1, 2A-2G, 3A-3E, 4A, 4B, and 5.

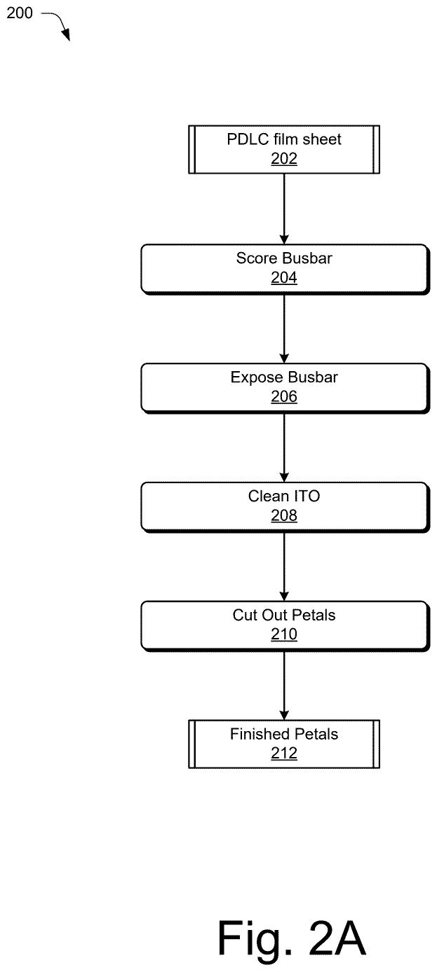

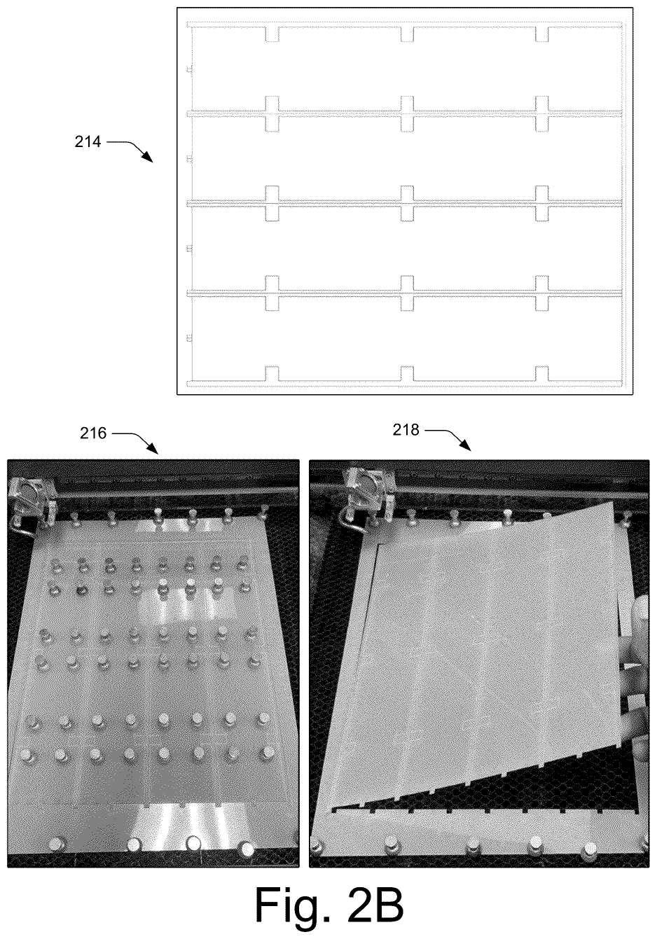

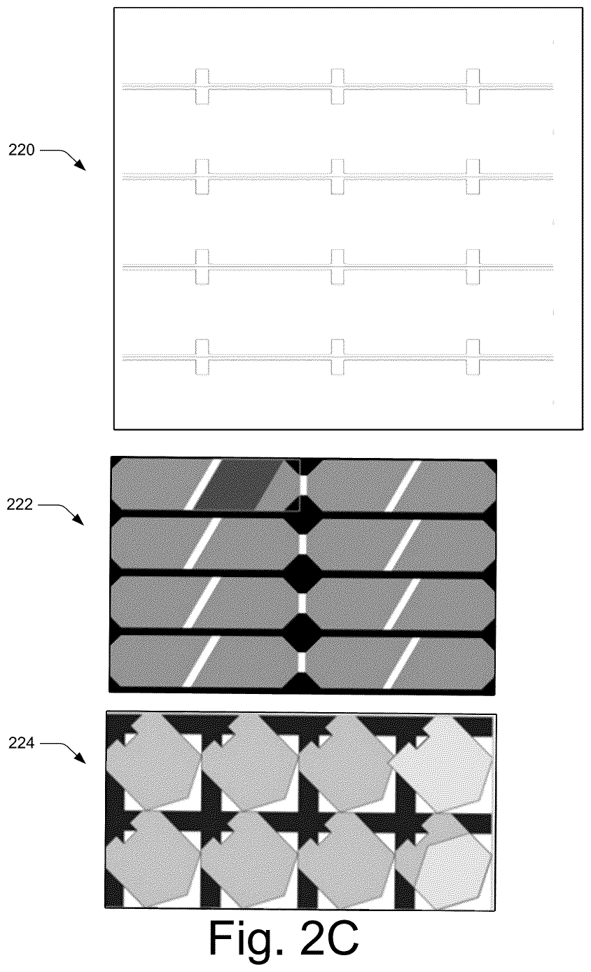

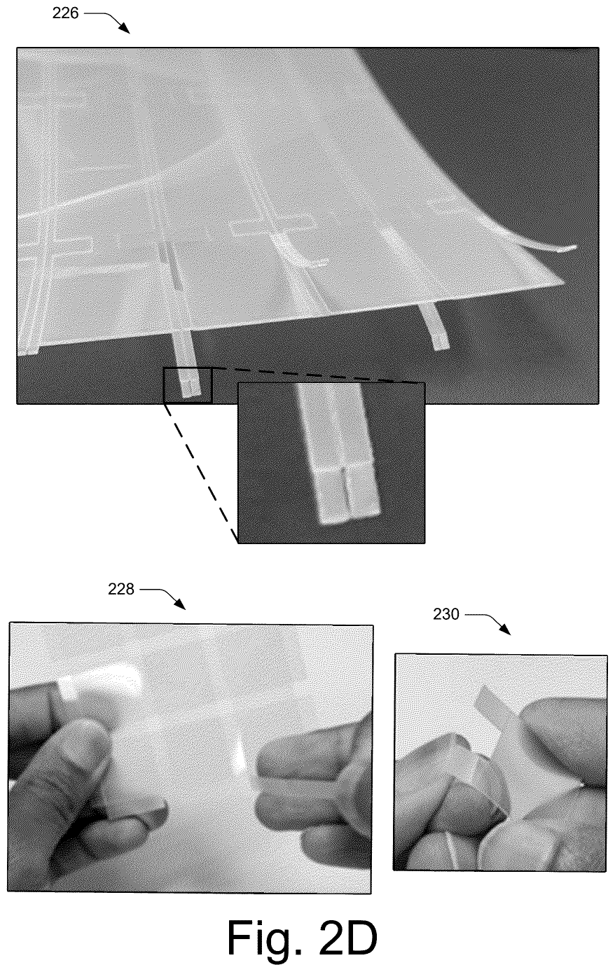

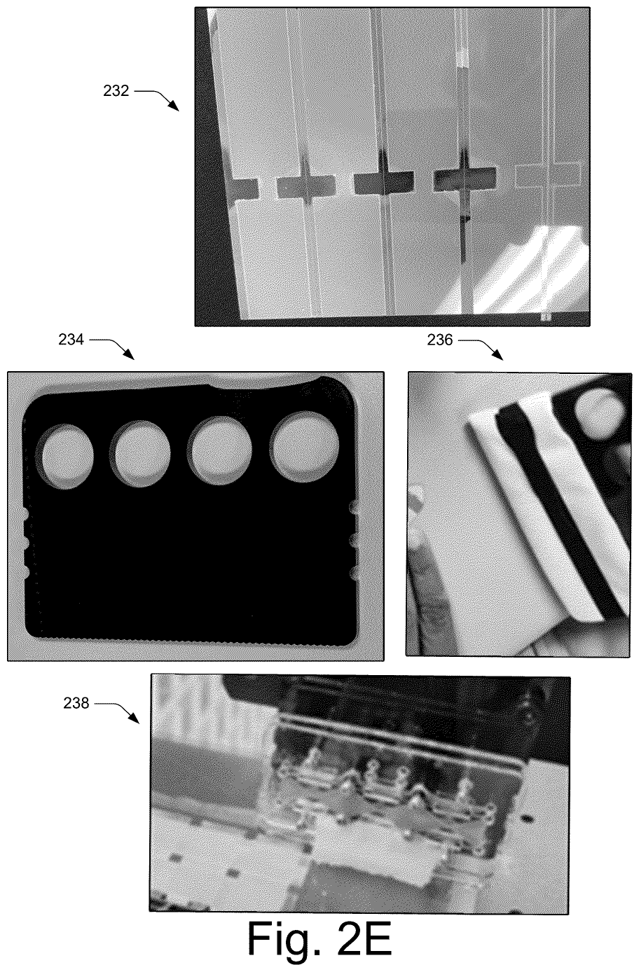

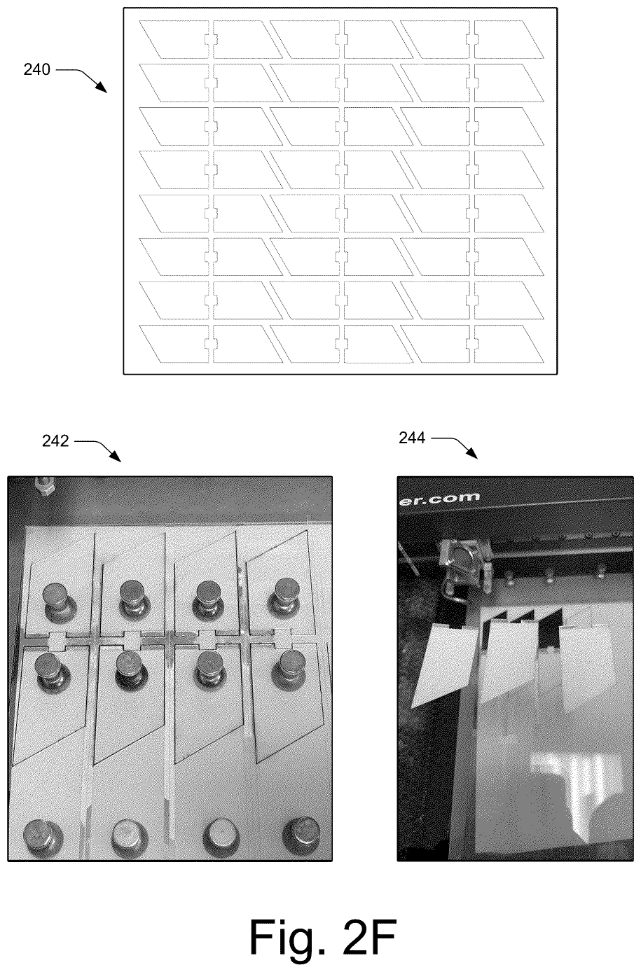

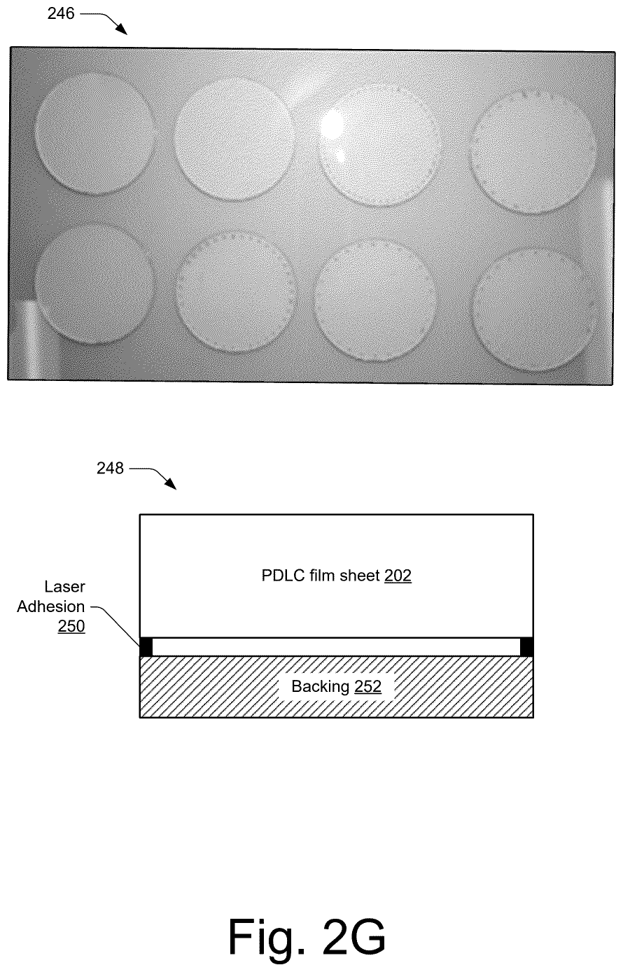

FIGS. 2A-2G is a flow diagram depicting a step-by-step procedure 200 in an example implementation of operations performable for rapid and parallelized production of modular light-diffuser devices.

As described above, a conventional manufacturing process for diffuser elements includes three general steps: preparation, cutting, and busbar exposure. In the preparation step, the adhesive side of a raw PDLC film sheet is mounted on a backing (e.g., mylar) with a brayer. In the cutting step, the busbar outlines are scored on both sides of the PDLC sheet with a laser cutter before the petal shape is cut out. During this step, the scoring and cutting are performed with magnets placed on the sheet to ensure the sheet is flat. In the final step, the busbar is created by exposing the ITO layer on each tab and wiping away the residual liquid crystal with a cloth. A blade or nail clipper is often used to separate the PDLC layers to expose the ITO for a busbar on each petal side. This busbar step usually takes up most of the time because each petal tab is processed individually. The magnet handling during the cutting step also takes considerable time because each magnet is placed and picked up twice (e.g., four touches total) for each petal.

Similarly, the described manufacturing procedure 200 begins with a PDLC film sheet 202 and follows three general steps: busbar scoring 204, busbar exposing 206 including wiping away liquid crystals 208 and petal cutting 210 to create finished petals 212.

In conventional manufacturing processes, the busbar outlines are scored along the same axis on both sides of the PDLC film sheet 202. As a result, the busbars are individually exposed for each petal. In contrast, the described procedure 200 scores the outlines along continuous axes, allowing the ITO to be aligned along a particular axis for each petal side (e.g., horizontal and vertical axes) and exposed simultaneously for multiple petals. Since the petal cutting has not occurred yet in procedure 200, the track can be cleaned for all (yet-to-be-cut) petals along each axis. Step 210 cuts the final petal shape out from the resulting busbar grid.

FIGS. 2B and 2C illustrate example implementations of busbar scoring 204 using parallel tabs. In view 214 of FIG. 2B, busbar outlines for even columns are scored along the red and green lines on the first side of the PDLC film sheet 202. In this example implementation, the different color lines represent different characteristics (e.g., cut order, laser frequency, laser power) for the scoring processing. In view 214, a green center line is scored between parallel busbar channels so that tabs are exposed individually instead of two at a time. In other implementations, a center line is omitted from busbar scoring 204 to reduce the number of outlines scored in this procedure and to expose the tabs two at a time.

During the busbar scoring 204, magnets are placed on the sheet to ensure the sheet is flat, as illustrated in view 216. Once the outlines are scored as illustrated in view 214, the PDLC film sheet 202 is flipped over as illustrated in view 218. Busbar outlines for odd columns are then scored along the colored lines on the second side of the PDLC film sheet 202, as illustrated in view 220.

In the busbar scoring 204, busbar outlines are scored on both sides of the PDLC film sheet 202 using parallel-quad tabs (as illustrated in view 222 of FIG. 2C), orthogonal tabs (as illustrated in view 224 of FIG. 2C) or another configuration to streamline the scoring process. The petal shapes can be arranged in groups of four to form parallel-quad tabs. In one implementation, the busbar outlines are scored orthogonal to each other along parallel axes where the corners of four petals meet (represented by the solid black lines in view 222 of FIG. 2C). Views 214, 220, and 222 of FIGS. 2B and 2C show the corners of where multiple petals meet. In view 222, the red parallelogram represents the display area of the petal shape and the blue area represents the additional switchable PDLC area for the corresponding petal. The green outline in view 222 represents the cutting outline for step 210 to cut out the final petal shape 212.

In other implementations, the busbar outlines are scored in different relative orientations to one another based on the petal shape and/or the configuration of the parallel-quad tabs. Parallel-quad tabs provide improved efficiency and higher yields than conventional processes because they require fewer tracks to expose the ITO, with less area to clean, and the petals can be packed more tightly together, resulting in less waste.

In view 224 of FIG. 2C, the busbar outlines on each side of the PDLC film sheet 202 are scored orthogonal to each other for orthogonal tabs. In view 224, the busbar outlines are represented by solid black lines. The display area of the petal shape is represented by the yellow polygon in the lower-right corner of the image, with the orange area not over the solid black lines representing the additional switchable PDLC area for the corresponding petal. In other implementations, the petals and busbar outlines can be arranged in other configurations to streamline the busbar scoring.

To improve the efficiency of the busbar scoring 204 and petal cutting 210, the described procedure 200 uses a magnet lift system to place and pick up multiple magnets simultaneously in at least one implementation. For example, a magnet lift system is used to place and pick up each magnet.

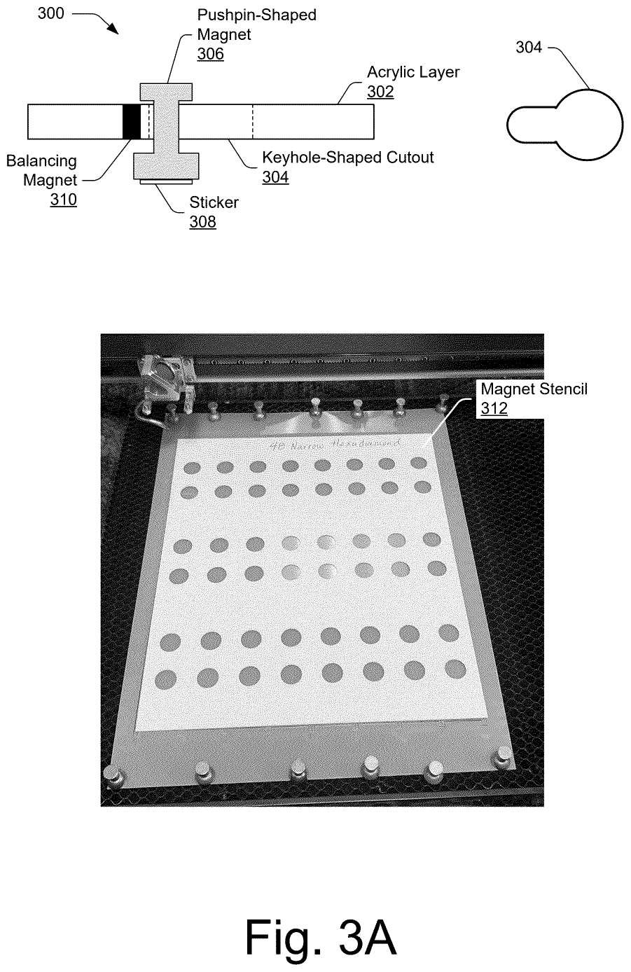

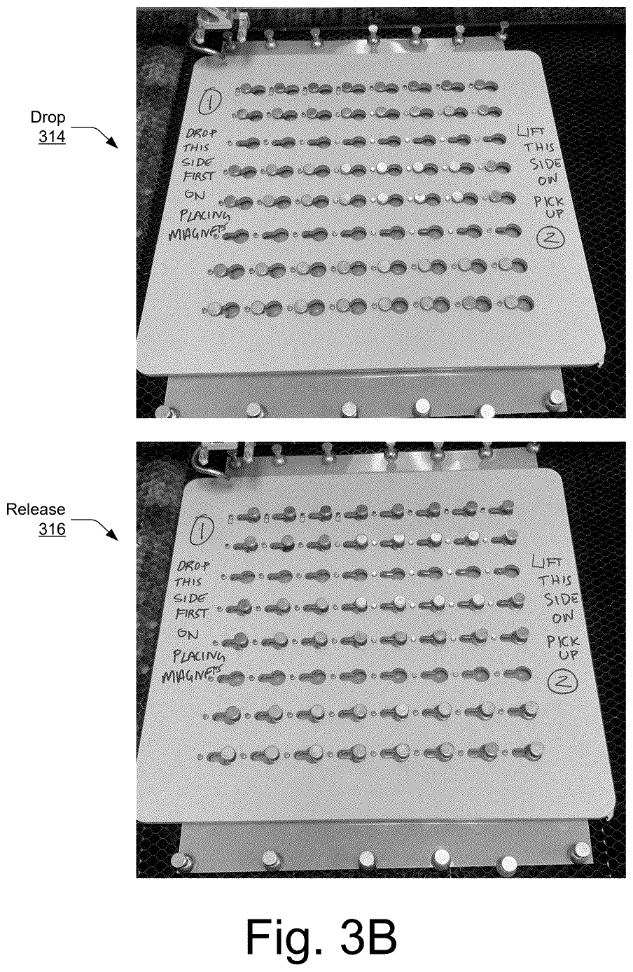

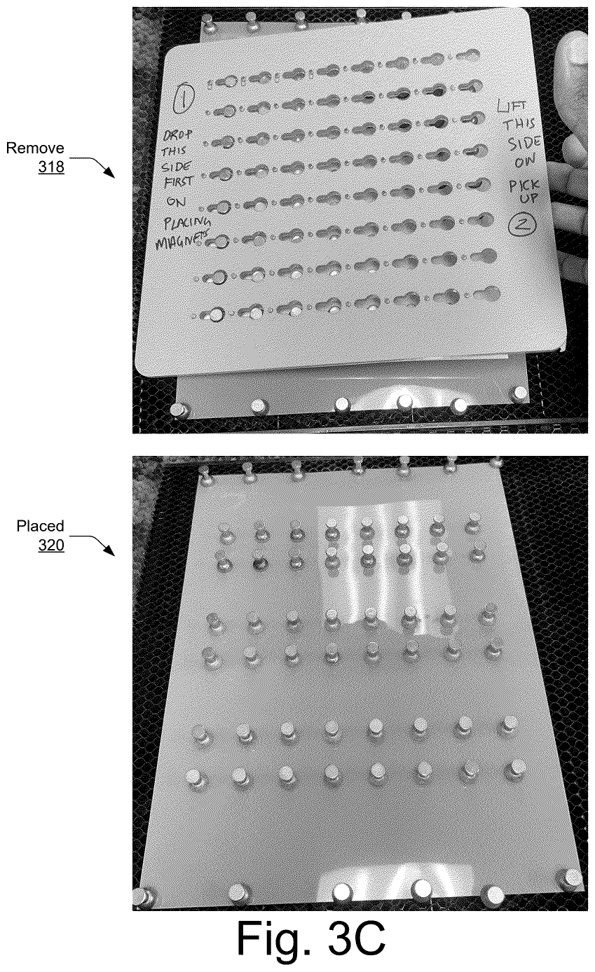

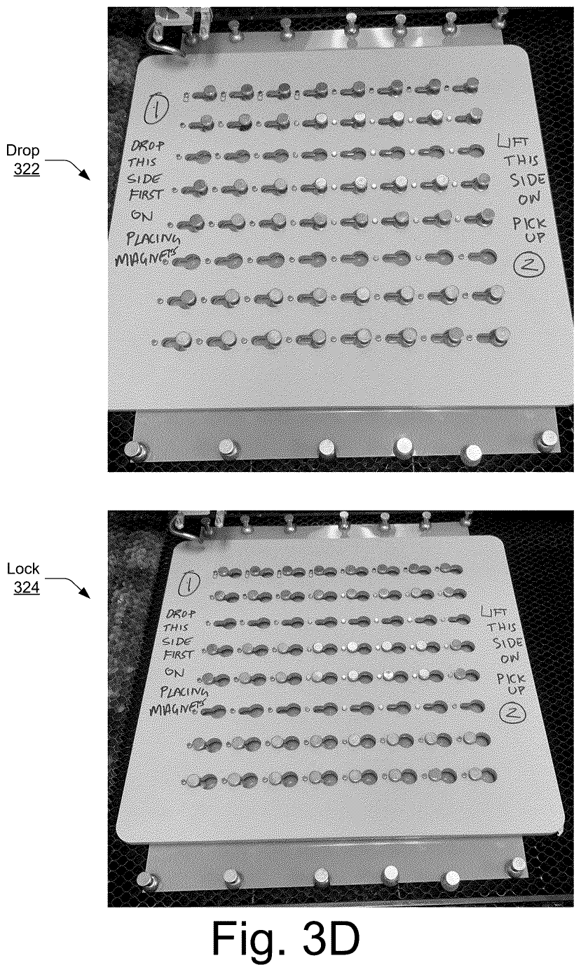

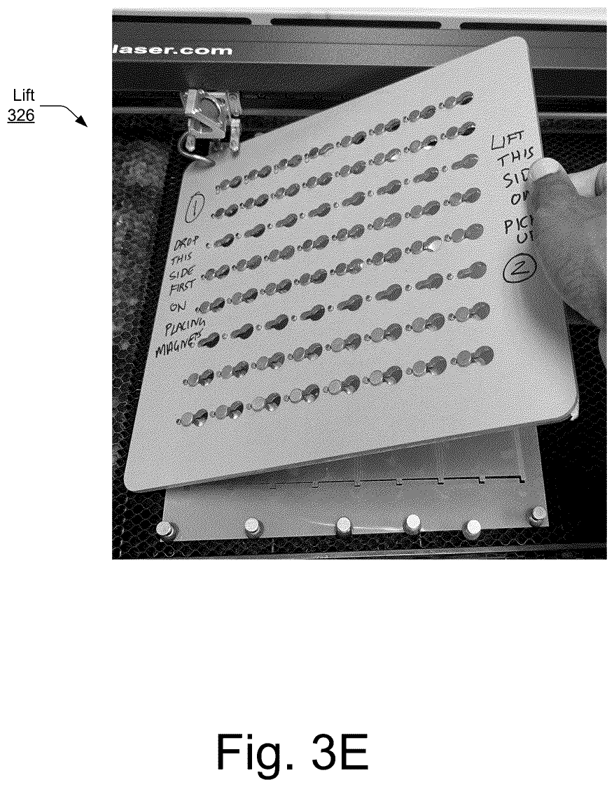

FIGS. 3A through 3E illustrate an example of a magnet lift system 300 to support rapid and parallelized production techniques for modular light-diffuser devices as described herein. The magnet lift system 300 includes an acrylic layer 302 (or similar material) with keyhole-shaped cutouts 304 for pushpin-shaped magnets 306, which include a sticker 308 on the bottom surface. The acrylic layer 302 also includes a balancing magnet 310 to hold or lock the pushpin-shaped magnet 306 within the recess of the keyhole-shaped cutout 304. The magnet lift system 300 can also utilize a magnet stencil 312 to assist with placing the pushpin-shaped magnets 306.

When loaded, the pushpin-shaped magnets 306 are secured in the keyhole-shaped cutouts 304 with smaller balancing magnets 310 on the bottom side or otherwise offset from the keyhole recess of the magnet lift system 300. The pushpin-shaped magnets 306 are dropped onto a ferrous surface onto which the PDLC film sheet is positioned (operation 314). Drop 314 can utilize the magnet stencil 312 to place the pushpin-shaped magnets 306. The pushpin-shaped magnets 306 are released simultaneously because the holding force (e.g., controlled with paper stickers 308 on the bottom surface of each magnet) to the ferrous surface is stronger than the force exerted by the balancing magnets 310 (operation 316). The magnet lift system 300 is then removed from the work area (operation 318), resulting in the pushpin-shaped magnets 306 being placed in the work area in preparation for the busbar scoring (operation 320).

After the busbar scoring is completed, the magnet lift system is dropped to position the pushpin-shaped magnets 306 within the larger portion of the keyhole-shaped cutouts 304 (operation 322). The magnet lift system 300 is then locked onto the pushpin-shaped magnets 306 by moving the acrylic layer 302 to position the pushpin-shaped magnets 306 within the recess of the keyhole-shaped cutouts 304 (operation 324). The pushpin-shaped magnets 306 are lifted simultaneously from the ferrous surface using the combination of the narrow recess of the keyhole-shaped cutouts 304 and the balancing magnets 310 (operation 326).

The busbar exposing 206 is performed by removing the easy-peel tabs for each column across the sheet (e.g., for multiple petals) as illustrated for parallel tabs in view 226 of FIG. 2D. Conventional processes use a blade, fingernail, or nail clipper to separate the PDLC layers and expose the ITO tabs. In contrast, procedure 200 utilizes easy-peel tabs that separate the layers, like peeling away the lining on an adhesive bandage, as illustrated in views 228 and 230 of FIG. 2D. The easy-peel tabs are created with two cuts, an overcut line and the tab line, as illustrated by the zoomed-in inset of view 226 of FIG. 2D. For example, the overcut line is solid, but the tab line is dashed (e.g., 0.1 mm ON, 0.1 mm OFF). In other implementations, the easy-peel tabs are generated with a tab line that is cut with a different frequency than the overcut line to create the dashed line.

The cleaning of ITO 208 is then performed by wiping away the liquid crystal using a hand tool (as illustrated in views 234 or 236 of FIG. 2E) or a detachable sponge mount (as illustrated in view 238 of FIG. 2E). Conventionally, a fingertip rubs a damp cloth with isopropyl alcohol or other compatible solvents on the exposed ITO until the residual liquid crystal is wiped away. This conventional approach is impractical for thousands of petals, each with two tabs on opposite sides. Instead, procedure 200 uses a cloth strapped to ridged-bottom hand tool (illustrated in view 234 of FIG. 2E) that cleans the tabs for multiple petals in a single linear motion. Alternatively, procedure 200 utilizes the detachable sponge mount. The liquid crystal removal is performed more quickly and efficiently by attaching a cleaning sponge to a computer numerical control (CNC) machine (e.g., with an XY gantry). The sponge tool path is programmable to follow the exposed ITO track shape created by the busbar scoring 204. View 232 of FIG. 2E illustrates an example PDLC film sheet 202 with the liquid crystal wiped away.

Procedure 200 then continues with petal cutting 310. View 240 of FIG. 2F illustrates the cut lines (represented by the pink lines) for the petal shapes in an example of a parallel-quad arrangement of petals. View 242 of FIG. 2F provides a photograph of the cut lines for a set of eight petals along the cut lines from view 240. Similarly, view 244 of FIG. 2F illustrates the petal shapes after extraction or removal from the PDLC film sheet 202.

The backing 252 (illustrated in view 248 of FIG. 2G) (e.g., mylar) is laid under the PDLC film sheet 202, and the petal shape is cut out with laser-welded edges. Conventionally, PDLC film sheets include a single-sided or double-sided adhesive to mount on a thin-film (e.g., mylar) backing. Due to internal reflection and the difference in refraction indices, the appearance of the PDLC film sheet adhered to the backing differs from when they are stacked because the air gap is filled with the adhesive. To maintain the latter appearance, procedure 200 laser welds the backing 252 to the PDLC film sheet 202 along the petal edges as illustrated in view 246 of FIG. 2G. In some implementations, the laser weld can be a continuous, dashed, or dotted line with one or more thin-film backing layers to generate laser adhesion 250 along the petal edges (as illustrated in view 248 of FIG. 2G), but other types of lines can be used for the laser welding.

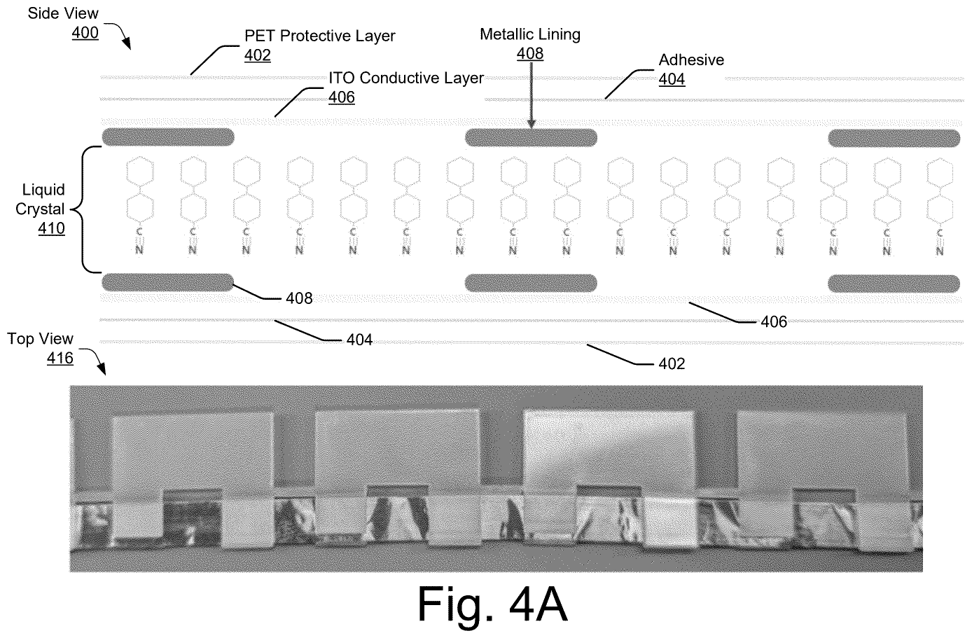

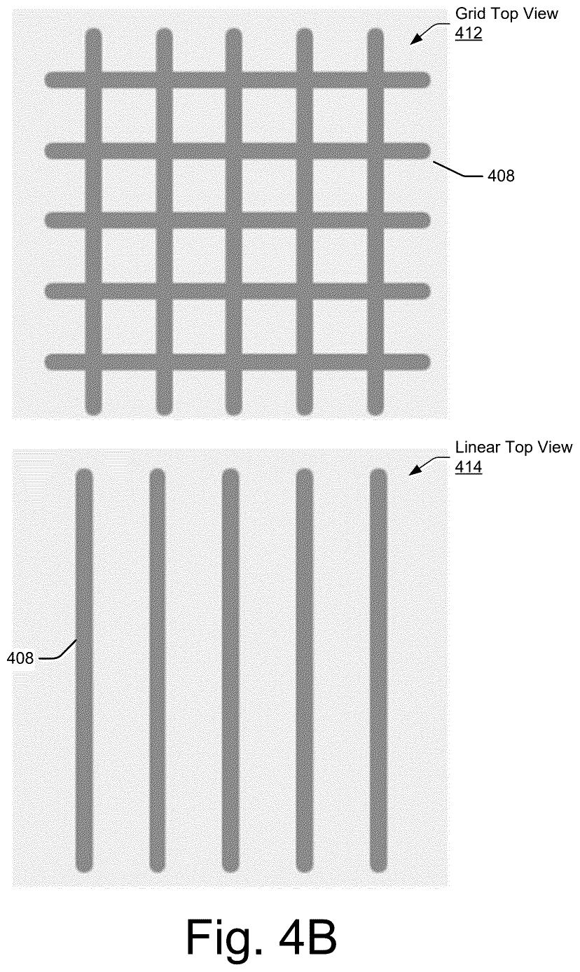

For procedure 200, the busbar exposing 206 and cleaning ITO 208 involves the most time, but procedure 200 still provides a production process that is several times faster and more efficient than the conventional approach. However, if a metal-lined PDLC film sheet (as described below with respect to FIGS. 4A and 4B) is used, steps 206 and 208 are eliminated from procedure 200 because the busbar scoring 204 leaves the ITO exposed without residual liquid crystal.

FIGS. 4A and 4B illustrate an example of a PDLC film sheet that is usable to employ rapid and parallelized production techniques for modular light-diffuser devices, as described herein.

Scoring the busbar outlines on both sides of the PDLC film sheet 202 generally involves a flip operation during laser cutting, then exposing the ITO and wiping away the residual liquid crystal. However, if the inside of the raw 2-layer PDLC film sheets 202 are lined with a grid of thin-metal strips (e.g., vertical on top and horizontal on bottom as illustrated in grid top view 412) for orthogonal tabs, steps 206 and 208 of procedure 200 with busbar exposing and liquid crystal cleaning are eliminated. In other implementations, the metal strips are arranged in one or more different patterns based on the tab and petal shape.

A side view 400 of the PDLC film sheet 202 with metallic linings 408 (e.g., adhesive copper tape) is illustrated in FIG. 4A. The PDLC film sheet 202 includes two polyethylene terephthalate (PET) protective layers 402, two adhesive layers 404, two ITO conductive layers 406, two layers of metallic lining 408, and a liquid crystal 410 (e.g., moving from the outside layer on one side through to the middle and back out in the reverse stack of layers). In one example, the liquid crystal 410 is a nematic liquid crystal. The metallic lining 408 can be arranged in an orthogonal grid, as shown in grid top view 412, or as parallel strips, as shown in linear top view 414, as shown in FIG. 4B. In other implementations, the metallic linings 408 are arranged in one-dimensional or two-dimensional arrangements based on the shape of the tabs and petals.

The top view 416 of FIG. 4A illustrates an example of metallic lining 408 applied to the PDLC film sheet. The metallic linings 408 prevent the CO₂ laser beam from cutting into the underlying ITO conductive layer 406 so that the ITO can be exposed without peeling tabs. Also, because the metallic linings 408 are added before the liquid crystal 410 is added, there is no residual liquid crystal 410 to clean on the exposed ITO. The metallic linings 408 are removed after the busbar outlines are cut but before the petal shape is cut out. In another implementation, the metallic linings are not removed (e.g., before or after petal cutting), with the metallic linings enhancing the conductivity of the ITO busbar system.

In another implementation, liquid crystal cleaning is eliminated from procedure 200 because the liquid crystals are removed as part of the busbar exposure. As the layer above the busbar is peeled away in step 206 of procedure 200, the liquid crystal is brought up with the protective layer. For example, one side of the PDLC film sheet is slightly heated before busbar exposure, and the protective layer on the other side is quickly removed or peeled away to pull up the underlying liquid crystal along with the protective layer to eliminate step 208 of the procedure 200 to make the manufacturing process more efficient.

### Example Computing Device

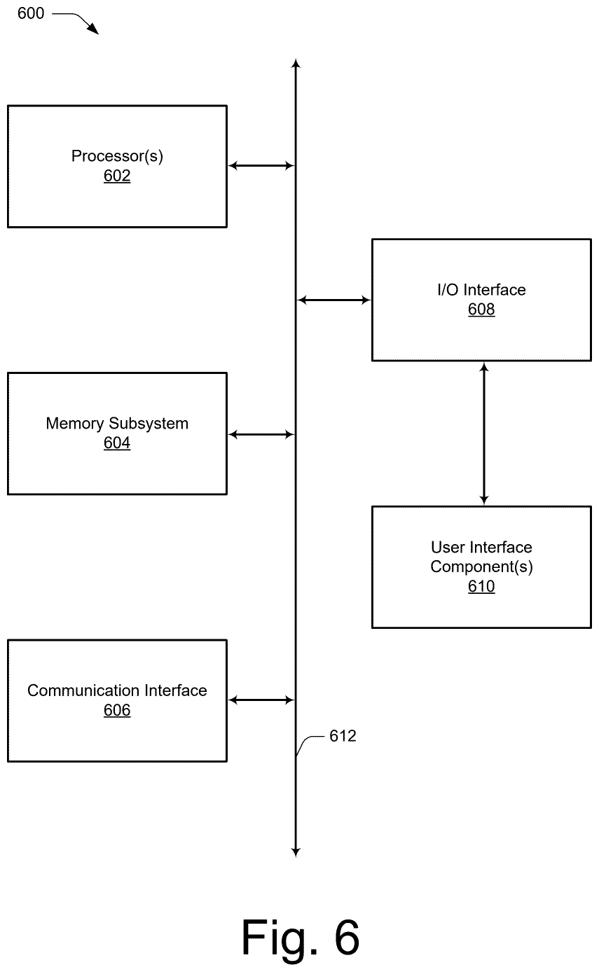

FIG. 6 illustrates an example of a computing device 600 according to aspects of the techniques described herein. The computing device 600 may implement a modular light-diffuser system that controls (e.g., directly or indirectly) one or more modular light-diffuser devices. In one aspect, computing device 600 includes processor(s) 602, memory subsystem 604, communication interface 606, I/O interface 608, user interface component(s) 610, and channel 612. Additional or alternative components may be used in other implementations.

In some embodiments, computing device 600 is an example of, or includes aspects of, the modular light-diffuser system 102 of FIG. 1. In one or more implementations, the computing device 600 is a mobile device (e.g., a laptop, a tablet, a smartphone, a mobile telephone, a camera, a tracker, a watch, a wearable device, etc.). In other implementations, the computing device 600 is a non-mobile device (e.g., a desktop computer, a server device, a web server, a file server, a social networking system, a program server, an application store, or a content provider). Further, the computing device 600 may be a server device that includes cloud-based processing and storage capabilities. In some embodiments, computing device 600 includes one or more processors 602 that can execute instructions stored in memory subsystem 604 to perform media generation.

According to some aspects, computing device 600 includes one or more processors 602. In some cases, a processor 602 is an intelligent hardware device (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof). In some implementations, a processor 602 is configured to operate a memory array using a memory controller. In other cases, a memory controller is integrated into a processor 602. In some implementations, a processor 602 is configured to execute computer-readable instructions stored in memory to perform various functions. In some embodiments, a processor 602 includes special-purpose components for modem processing, baseband processing, digital signal processing, or transmission processing.

According to some aspects, memory subsystem 604 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software, including instructions that, when executed, cause a processor to perform various functions described herein. In some implementations, the memory contains, among other things, a basic input/output system (BIOS) that controls basic hardware or software operations, such as the interaction with peripheral components or devices. In some implementations, a memory controller operates memory cells. For example, the memory controller can include a row decoder, column decoder, or both. In some cases, memory cells within a memory store information in the form of a logical state.

According to some aspects, communication interface 606 operates at a boundary between communicating entities (such as computing device 600, one or more user devices, a cloud, and one or more databases) and channel 612 and can record and process communications. In some implementations, communication interface 606 enables a processing system coupled to a transceiver (e.g., a transmitter and/or a receiver). In some examples, the transceiver is configured to transmit (or send) and receive signals for a communications device via an antenna.

According to some aspects, I/O interface 608 is controlled by an I/O controller to manage input and output signals for computing device 600. In some implementations, I/O interface 608 manages peripherals not integrated into computing device 600. In some implementations, I/O interface 608 represents a physical connection or port to an external peripheral. In some implementations, the I/O controller uses an operating system such as iOS®, ANDROID®, MS-DOS®, MS-WINDOWS®, OS/2®, UNIX®, LINUX®, or other known operating system. In some implementations, the I/O controller represents or interacts with a modem, a keyboard, a mouse, a touchscreen, or a similar device. In some implementations, the I/O controller is implemented as a component of a processor. In some implementations, a user interacts with a device via I/O interface 608 or via hardware components controlled by the I/O controller.

According to some aspects, user interface component(s) 610 enable a user to interact with computing device 600. In some implementations, user interface component(s) 610 include an audio device, such as an external speaker system, an external display device, such as a display screen (e.g., with a modular light-diffuser device 108), an input device (e.g., a remote-control device interfaced with a user interface directly or through the I/O controller), or a combination thereof. In some implementations, user interface component(s) 610 include a GUI.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on various commercial computing platforms with various processors.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
scoring busbar outlines on each side of a polymer dispersed liquid crystal (PDLC) film sheet for multiple petals of a modular light-diffuser system;
simultaneously exposing a busbar on each side of the PDLC film sheet for the multiple petals; and
cutting out petal shapes for the multiple petals.

2. The method of claim 1, wherein the busbar outlines are scored along orthogonal axes to align a first busbar on a first side of the multiple petals along a first axis and a second busbar on a second side of the multiple petals along a second axis, the second axis being orthogonal to the first axis.

3. The method of claim 1, wherein:
the petal shapes for the multiple petals are arranged in groups of four petals; and
the busbar outlines are scored along continuous axes.

4. The method of claim 1, wherein exposing the busbar on each side of the PDLC film sheet for the multiple petals comprises:
removing PDLC layers along the busbar outlines on each side of the PDLC sheet for the multiple petals; and
wiping away liquid crystals from the busbar.

5. The method of claim 4, wherein the PDLC layers along the busbar outlines are removed using tabs, the tabs created by cutting a solid overcut line and a dashed tab line to allow the PDLC layers to be peeled away.

6. The method of claim 4, wherein the wiping away of the liquid crystals is performed using a cloth attached to a ridged-bottom hand tool or a sponge attached to an XY gantry of a computer numerical control (CNC) machine to allow the liquid crystals for the multiple petals to be wiped away in one or more linear or circular motions.

7. The method of claim 1, wherein cutting out the petal shapes comprises laying a backing on the PDLC film sheet and cutting the petal shapes with laser-welded edges using a laser cutter.

8. The method of claim 7, wherein the laser-welded edges include a continuous, dashed, or dotted line.

9. The method of claim 1, wherein the petal shapes include a rectangular, rounded, curved, pointed, petal, parallelogram, or concave shape.

10. The method of claim 1, wherein the method further comprises simultaneously placing and picking up multiple magnets using a magnet lift system before and after scoring the busbar outlines and cutting out the multiple petals.

11. The method of claim 10, wherein the magnet lift system includes a sheet with keyhole-shaped cutouts for each magnet of the multiple magnets, each magnet being secured in the cutout of the magnet lift system with a balancing magnet on a recessed side of the keyhole.

12. A method comprising:
scoring busbar outlines on each side of a polymer dispersed liquid crystal (PDLC) film sheet for multiple petals of a modular light-diffuser device, the PDLC film sheet including one or more metal linings along the busbar outlines; and
cutting out petal shapes for the multiple petals.

13. The method of claim 12, wherein the metal linings comprise adhesive copper tape.

14. The method of claim 12, wherein the PDLC film sheet comprises, from one side to another side, a first polyethylene terephthalate (PET) protective layer, a first adhesive layer, a first indium tin oxide (ITO) layer, a first metal lining, a nematic liquid crystal layer, a second metal lining, a second ITO layer, a second adhesive layer, a second PET protective layer.

15. The method of claim 12, wherein:
the busbar outlines are scored to align a first busbar on a first side of the multiple petals along a first axis and a second busbar on a second side of the multiple petals along a second axis, the second axis being non-parallel to the first axis; and
the metal lining is arranged along the orthogonal axes.

16. The method of claim 12, wherein:
the petal shapes for the multiple petals are arranged in groups of four petals;
the busbar outlines are scored orthogonal to each other along continuous axes; and
the metal lining is arranged along the parallel axes.

17. The method of claim 12, wherein cutting out the petal shapes comprises laying a backing on the PDLC film sheet and cutting the petal shapes with laser-welded edges using a laser cutter.

18. The method of claim 17, wherein the laser-welded edges include a continuous, dashed, or dotted line.

19. The method of claim 12, wherein the petal shapes include a rectangular, rounded, curved, pointed, petal, parallelogram, or concave shape.

20. A method comprising:
simultaneously scoring busbar outlines on a first side of a polymer dispersed liquid crystal (PDLC) film sheet for multiple petals of a modular light-diffuser device;
simultaneously scoring the busbar outlines on a second side of the PDLC film sheet for the multiple petals;
removing PDLC layers along the busbar outlines on each side of the PDLC sheet for the multiple petals;
wiping away liquid crystals from the busbar for the multiple petals on each side of the PDLC sheet; and
cutting out petal shapes for the multiple petals.
